(19) United States
(12) Patent Application Publication
(10) Pub. No.: US 2015/0195213 A1
(43) Pub. Date: Jul. 9, 2015

(54) REQUEST DISTRIBUTION METHOD AND INFORMATION PROCESSING APPARATUS

(71) Applicant: FUJITSU LIMITED, Kawasaki-shi (JP)

(72) Inventor: Takahiko Orita, Kawasaki (JP)

(73) Assignee: Fujitsu Limited, Kawasaki (JP)

(21) Appl. No.: 14/571,904

(22) Filed: Dec. 16, 2014

(30) Foreign Application Priority Data
Jan. 9, 2014 (JP) 2014-002644

(51) Int. Cl. H04L 12/911

(52) U.S. Cl. CPC H04L 47/70

(57) ABSTRACT

A non-transitory computer-readable recording medium stores therein a program for causing a computer to execute a process. The process includes receiving a request regarding a function that is implemented by a server; and specifying a server to implement a function requested by the received request on the basis of first information that associates one of multiple functions that are implemented by a server with a server that includes hardware necessary to implement the function.

### CROSS-REFERENCE TO RELATED APPLICATIONS

This application is based upon and claims the benefit of priority of the prior Japanese Patent Application No. 2014-002644, filed on Jan. 9, 2014, the entire contents of which are incorporated herein by reference.

### FIELD

The embodiments discussed herein are related to a request distribution program, a request distribution method, and an information processing apparatus.

### BACKGROUND

Various services have been provided by cloud computing. For example, design assist services for assisting with circuit designing by cloud computing are provided. The design assist services, for example, run a computer aided design (CAD) program on a server. The design assist services accept an operation from a client via a network. Furthermore, the design assist services transmit image information that is generated on the server according to the accepted operation to the client and the client displays the image. In this manner, the design assist services can provide the designer with a design environment equivalent to a design environment in which CAD runs on the client.

Patent Document 1: Japanese Laid-open Patent Publication No. 2007-4303

Patent Document 2: Japanese Laid-open Patent Publication No. 2005-513597

In cloud computing, when high-performance servers are used for all servers that are used to provide the services, the costs for building the system increase. Furthermore, the functions provided by the services include functions that are sufficiently implemented with the processing performance of a low-performance server, such as an old-type server, not by a high-performance server. For example, in the design assist services, the performance of a low-performance server may be satisfactory depending on the CAD function used for designing. For this reason, the servers that are used to provide the services may include both of high-performance servers and low-performance servers.

However, when the servers used to provide the services include both of high-performance servers and low-performance servers, it is difficult to allocate processing efficiently to the servers.

A portal of the design assist services will be described here with reference to FIG. 1. FIG. 1 illustrates an exemplary system 10 that provides design assist services. A designer accesses a request distribution apparatus 20 that is the portal of the system 10, using a client 12, logs in the design assist services, and selects a server (application server 21) to be used for circuit designing. The request distribution apparatus 20 builds a design environment in the selected server. In this case, if a low-performance server is selected, the processing time extends depending on the CAD function, which may be a problem in the designing operations. In such a case, the designer ends the designing operation once, then reselects a server that can implement the function comfortably, and performs designing operations.

When each designer does not want to intermit the designing operations and selects high-performance servers each capable implement all functions comfortably, the high-performance servers are used exclusively so that the usage efficiency of low-performance servers lowers. Furthermore, when the high-performance servers are used exclusively, it is difficult to use a high-performance server for a designer that uses a function that can be implemented comfortably by only high-performance servers.

### SUMMARY

According to an aspect of an embodiment, a non-transitory computer-readable recording medium stores therein a program for causing a computer to execute a process. The process includes receiving a request regarding a function that is implemented by a server; and specifying a server to implement a function requested by the received request on the basis of first information that associates one of multiple functions that are implemented by a server with a server that includes hardware necessary to implement the function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary schematic configuration of a whole system;

FIG. 2 illustrates an exemplary functional configuration of a request distribution apparatus;

FIG. 3 is a table of an exemplary data structure of function information;

FIG. 4 is a table of an exemplary data structure of server information;

FIG. 5 is a table of an exemplary data structure of request source information;

FIG. 6 is a sequence diagram of exemplary general operations of the system;

FIG. 7 is a sequence diagram of exemplary detailed operations of the system;

FIG. 8 illustrates the flow of processing for determining whether to switch an application server;

FIG. 9 illustrates the flow of processing for selecting an application server to which the application server is switched;

FIG. 10 illustrates the flow of processing for updating the server information;

FIG. 11 illustrates the flow of processing for updating the request source information;

FIG. 12 is a sequence diagram of exemplary general operations of the system that are performed when multiple clients perform circuit designing;

FIG. 13 is a sequence diagram of exemplary detailed operations of the system that are performed when multiple clients perform circuit designing;

FIG. 14 illustrates a flow of processing for updating the server information;

FIG. 15 illustrates a flow of processing for determining whether to transfer the design environment of any one of application servers;

FIG. 16 illustrates a flow of processing for determining whether it is possible to transfer the design environment;

FIG. 17 illustrates a flow of processing for updating the server information;

FIG. 18 is a flowchart of an exemplary procedure of request distribution processing; and

FIG. 19 illustrates a computer that executes a request distribution program.

### DESCRIPTION OF EMBODIMENTS

Preferred Embodiments of the Present Invention will be explained with reference to accompanying drawings. The embodiments do not limit the invention. Each embodiment can be combined as long as no contradiction is caused in the content of the processing.

### [a] First Embodiment

System Configuration

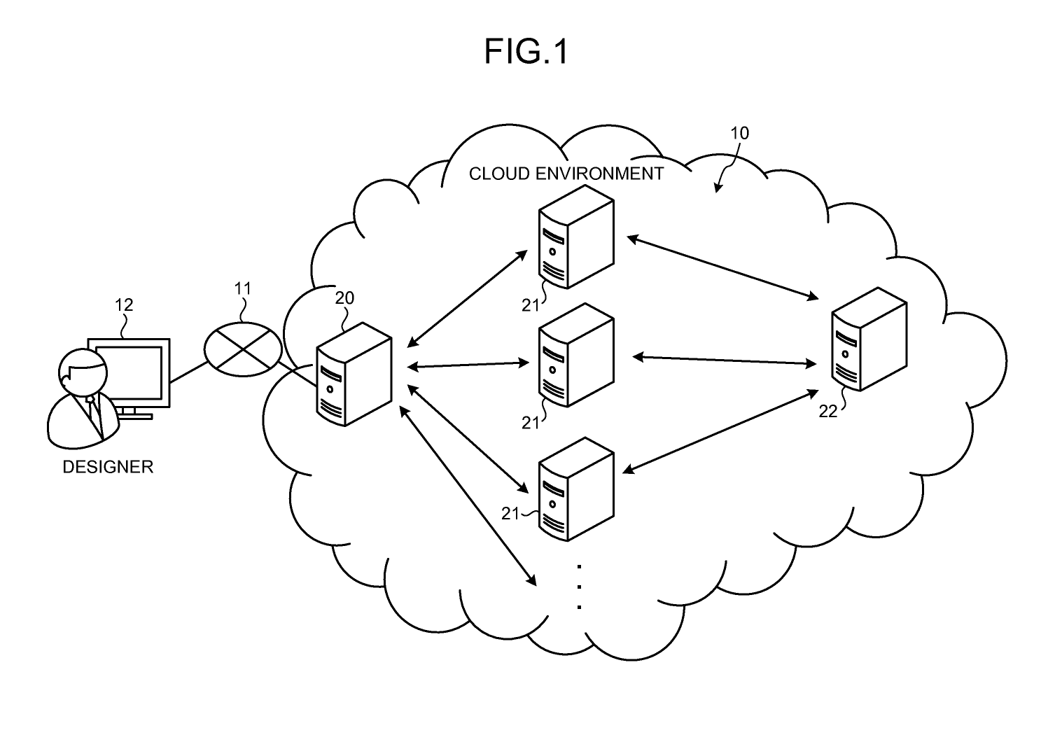

A system 10 according to a first embodiment will be described below. FIG. 1 illustrates an exemplary schematic configuration of a whole system. The system 10 provides services by cloud computing. An exemplary case will be described below where the system 10 provides design assist services as services. The system 10 is communicably connected to the client 12 via a network 11 so as to communicate various types of information with the client 12. An embodiment of the network 11 is, for example, regardless whether it is wired or wireless, an arbitrary communication network, such as the Internet, a local area network (LAN), or a virtual private network (VPN).

The client 12 is a computer that is used by a designer for circuit designing. The client 12 is, for example, a desktop PC (personal computer) or a laptop PC. A designer transmits various requests regarding circuit designing to the system 10, using the client 12, and performs circuit designing, using a design environment that is provided by the system 10. In the FIG. 1 example, one client 12 is used. Alternatively, an arbitrary number of clients 12 may be used.

The system 10 provides a design environment for performing circuit designing. The system 10 accepts various requests regarding circuit designing from the client 12 via the network 11. Upon accepting a request, the system 10 performs processing according to the accepted request. The system 10 then transmits image information obtained by performing the processing to the client 12 and the client 12 displays the image. As illustrated in FIG. 1, the system 10 includes a request distribution apparatus 20, application servers 21, and a file server 22. The request distribution apparatus 20, the application servers 21, and the file server 22 are communicably connected to one another via a network (not illustrated) such that various types of information can be exchanged. An embodiment of the network is, for example, regardless whether it is wired or wireless, a communication network, such as a LAN or a VPN. FIG. 1 illustrates that three application servers 21 are used. Alternatively, an arbitrary number of application servers 21 may be used. FIG. 1 illustrates that one request distribution apparatus 20 and one file server 22 are used. Alternatively, each of the request distribution apparatus 20 and the file server 22 may consist of multiple server computers.

The request distribution apparatus 20 is a computer that functions as a portal that accepts a request from the client 12, i.e., an example of an information processing apparatus. The request distribution apparatus 20 is, for example, a server computer that is provided to a data center or each company. The request distribution apparatus 20 relays the accepted request from the client 12 to the application server 21. The request distribution apparatus 20 relays information resulting from processing performed by the application server 21 to the client 12.

The application server 21 is a computer that provides a design environment. The application server 21 is, for example, a server computer that is provided to the data center or each company. The application server 21 runs a CAD program to perform processing according to the request that is received from the client 12 via the request distribution apparatus 20. The application server 21 generates information obtained by performing the processing, such as image information obtained by performing the processing, and transmits the information to the client that is the source of the request.

The file server 22 is a computer that stores various types of data that is used for circuit designing. The file server 22 is, for example, a server computer that is provided to the data center or each company. The file server 22 stores various types of data, such as design data and various types of setting information, and provides various types of data according to the request from the application server 21.

Configuration of Request Distribution Apparatus

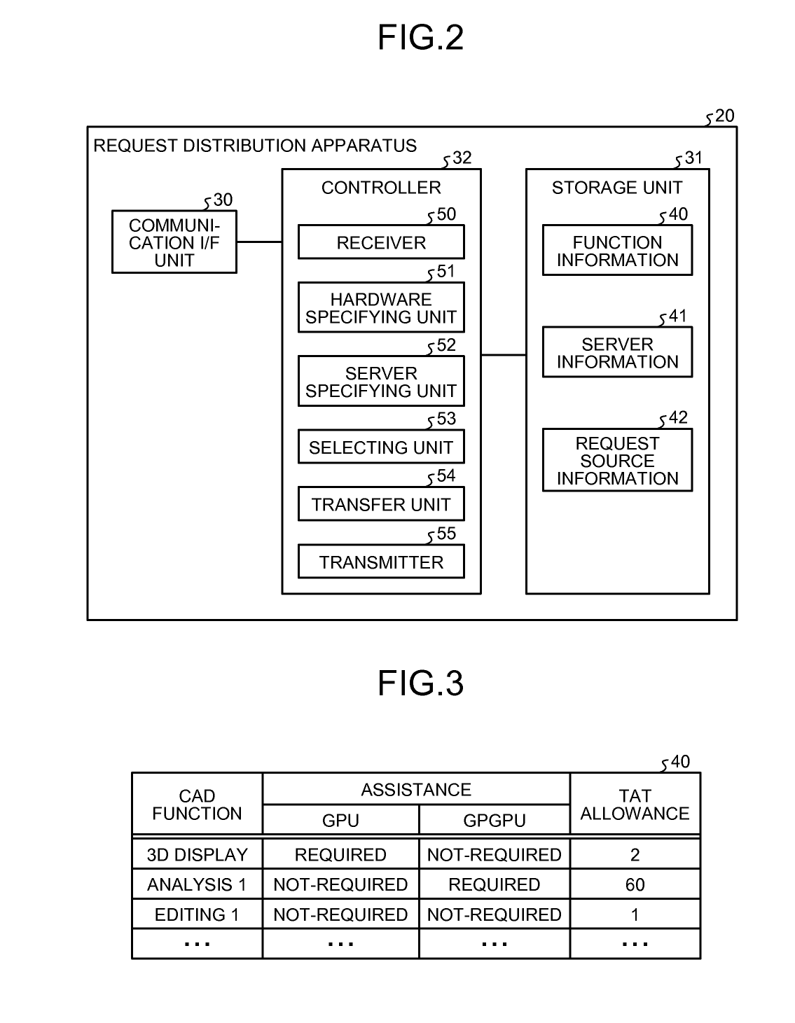

A request distribution apparatus according to a first embodiment will be described here. FIG. 2 illustrates an exemplary functional configuration of the request distribution apparatus. As illustrated in FIG. 2, the request distribution apparatus 20 includes a communication I/F unit 30, a storage unit 31, and a controller 32.

The communication I/F unit 30 is an interface that controls communications with other devices. The communication I/F unit 30 transmits/receives various types of information to/from other devices via a network (not illustrated). For example, the communication I/F unit 30 receives a request regarding various CAD functions from the client 12 and transmits the received request to an application server 21. The communication I/F unit 30 then receives, from the application server 21, image information obtained by performing processing according to the received request and transmits the received image information to the client 12 that transmits the request, i.e., that is the request source. For the communication I/F unit 30, a network interface card, such as a LAN card, can be used.

The storage unit 31 is a storage device, such as a semiconductor memory device such as a flash memory, a hard disk, or an optical disk. The storage unit 31 may be a data rewritable semiconductor memory, such as a random access memory (RAM), a flash memory, or a non-volatile static random access memory (NVSRAM).

The storage unit 31 stores an operating system (OS) that is caused to run by the controller 32 and various programs for processing received requests. The storage unit 31 further stores various types of data used for the programs executed by the controller 32. For example, the storage unit 31 stores function information 40, server information 41, and request source information 42.

The function information 40 is information that associates the various CAD functions and sets of hardware used to implement the functions. For example, the function information 40 stores, for each of the various CAD functions, information on hardware suitable to implement the function.

FIG. 3 is a table of an exemplary data structure of function information, i.e., an example of second information. For the function information 40, a table that associates items of CAD function, assistance, TAT allowance, etc. can be used. The CAD function item is an area for storing CAD functions available in the design assist services. The assistance item is an area for storing information on hardware used to implement the CAD functions. In the embodiment, the assistance item is divided into items of GPU and GPGPU. The GPU item is an area for storing information of whether to use a graphics processing unit (GPU) to implement the CAD functions. The GPGPU item is an area for storing information of whether to use general-purpose computing on graphics processing units (GPGPU) to implement the CAD functions. For the GPU and GPUGPU items, “required” is set when the GPU/GPGPU is used to implement the CAD function and “not-required” is set when the GPU/GPGPU does not have to be used to implement the CAD function. The TAT allowance item is an area for storing a turnaround time (TAT) that is allowed for the processing performance of the function. The TAT represents the time from when a request is received from a client 12 until a response to the request is sent to the client.

FIG. 3 example represents that the function of three-dimensional (3D) display uses the GPU, not the GPGP, and that the maximum allowable turnaround time is “2”. It is also represented that the function of analysis 1 does not use the GPU but uses the GPGPU and that the maximum allowable turnaround time is “60”. It is also represented that the function of Editing 1 uses neither the GPU nor the GPGP and that the allowable maximum turnaround time is “1”.

The GPU is a semiconductor chip that performs calculations for 3D graphic displays. A server that includes a GPU can use the GPU for 3D displays so that a 3D display can be made in a short processing time. For this reason, 3D displays are preferably processed by an application server 21 that includes a GPU. A GPGPU has a function of using the arithmetic operation function of the GPU for purposes other than image processing. A server that includes a GPU that has the GPUGPU function can perform relatively simple calculations in parallel at high speed so that analysis processing etc. can be performed in a short processing time. For this reason, the analysis is preferably performed by an application server 21 that includes a GPGPU.

The following description refers back to FIG. 2. The server information 41 associates the application servers 21 and the hardware of the application servers 21. For example, the server information 41 stores, per application server 21, information on the hardware of the application server 21 and information on the performance.

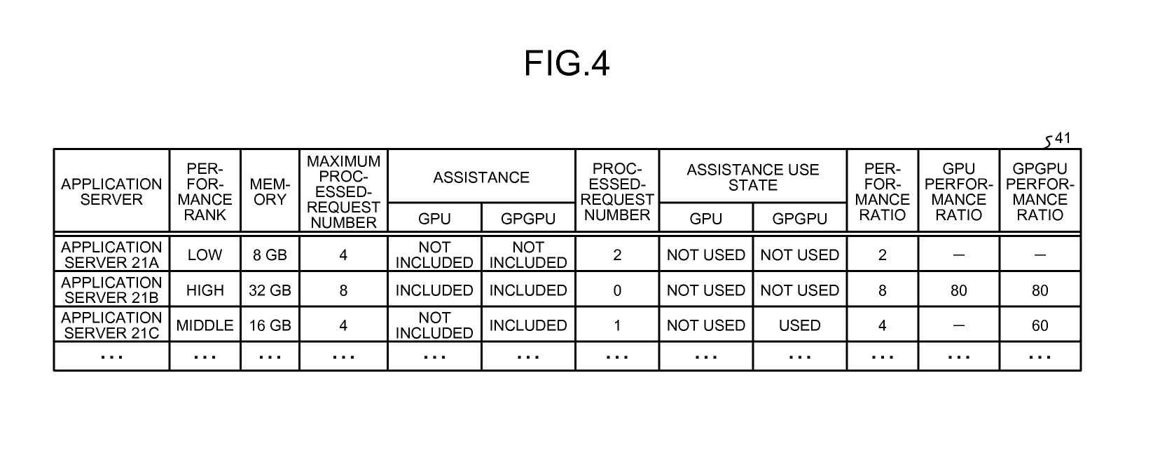

FIG. 4 is a table of an exemplary data structure of server information, i.e., an example of third information. For the server information 41, a table can be used that associates items of application server, performance rank, memory, maximum processed-request number, assistance, processed-request number, assistance use state, performance ratio, GPU performance ratio, GPGPU performance ratio, etc. The application server item is an area for storing identification information that identifies the application servers 21. For the identification information, any information that can identify the application servers 21, e.g. host names or IP addresses, can be used. For the first embodiment, an exemplary case will be described where three application servers 21 are used. In the following descriptions, the three application servers 21 are referred to as application servers 21A, 21B, and 21C to identify the application servers 21. Furthermore, to easily identify each application server 21, these reference numerals are used as the identification information on the respective application servers 21. The performance rank item is an area for storing information on the performance of the application servers 21. In the first embodiment, for the information on the performance, rank information is used that indicates the performance of the application servers 21 at three stages: high, middle, low. The memory item is an area for storing the capacity of the RAMs mounted on the application servers 21. The maximum processed-request number item is an area for storing the maximum number of requests that can be processed by the application server 21 during the same period. The value of the maximum processed-request number serves as a threshold for determining whether the number of requests being processed by the application server 21 reaches the upper limit. The assistance item is an area for storing information of whether the application servers 21 include hardware suitable for implementing the CAD functions. In the embodiment, the assistance item is divided into items of GPU and GPGPU. The GPU item is an area for storing information of whether the application server 21 includes a GPU. The GPGPU item is an area for storing information of whether the application server 21 includes a GPU with a GPGPU function. For the GPU and GPGPU items, “included” is set when the application server 21 includes corresponding hardware and “not included” is set when the application server 21 does not include corresponding hardware. The processed-request number item is an area for storing the number of requests being processed by the application server 21 during the same period. The assistance use item is an area for storing information of whether the hardware in the assistance item is used. In the first embodiment, the assistance use state item is divided into items of GPU and GPGPU. The GPU item is an area for storing information of whether the application server 21 uses the GPU. The GPGPU item is an area for storing information of whether the application server 21 uses GPGPU. The performance ratio item is an area for storing the processing performance of each application server 21. The GPU performance ratio item is an area for storing the processing performance of the GPG of each application server 21. The GPGPU performance ratio item is an area for storing the processing performance of GPGPU of each application server 21. If there is no corresponding hardware, “-” is set for the GPU performance ratio item and the GPGPU performance ratio item, i.e., the performance ratio is not illustrated.

The FIG. 4 example represents, regarding the application server 21A, that the performance rank is “low”, the capacity of the mounted RAM is “8 GB”, the maximum number of requests that can be processed during the same period is “4”, and the application server 21A does not include any GPU and does not have GPGPU. Regarding the application server 21A, it is also represented that the number of requests being processed is “2”, neither GPU nor GPGPU is used, the performance ratio is “2”, and “-” is set for the GPU performance ratio, i.e., the GPU performance ratio is not illustrated, and “-” is set for the GPGPU performance ratio, i.e., the GPGPU performance ratio is not illustrated. Regarding the application server 21B, it is represented that the performance rank is “high”, the capacity of the mounted RAM is “32 GB”, the maximum number of requests that can be processed during the same period is “8”, and GPU and a GPGPU. It is also represented, regarding the application server 21B, that the number of requests being processed is “0”, neither GPU nor GPGPU is used, the performance ratio is “8”, the GPU performance ratio is “80”, and the GPGPU performance ratio is “80”. Regarding the application server 21C, it is represented that the performance rank is “middle”, the capacity of the mounted RAM is “16 GB”, the maximum number of requests that can be processed during the same period is “4”, and the application server 21C includes a GPGPU. Regarding the application server 21C, it is also represented that the number of requests being processed is “1”, the GPGPU is used, “-” is set for the performance ratio, i.e., the performance ratio is not illustrated, the GPU performance ratio is “4”, and the GPGPU performance ratio is “60”.

The following description refers back to FIG. 2. The request source information 42 is information that associates the request sources that issue requests and the application servers 21. For example, the request source information 42 stores, per request source that issues a request, an application server 21 with a design environment in which the processing requested by the request source is performed and information on the function being implemented.

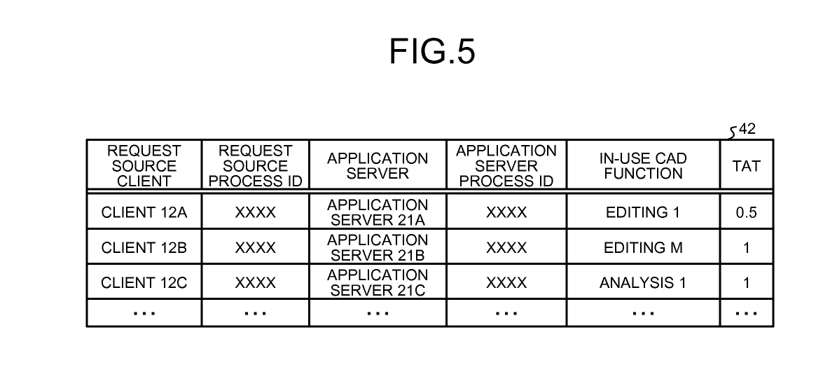

FIG. 5 is a table of an exemplary data structure of request source information, i.e., an example of fourth information. For the request source information 42, a table can be used that associates items of request source client, request source process ID, application server, application server process ID, in-use CAD function, TAT, etc. The request source client item is an area for storing identification information that identifies the client 12 that transmits the request for the CAD function. For the identification information, any information that can identify the client 12, e.g. the host name or IP address, may be used. For the first embodiment, an exemplary case will be described where three clients 12 are used. In the following descriptions, the three clients 12 are referred to as clients 12A, 12B, and 12C to identify the clients 12. Furthermore, to easily identify each client 12, these reference numerals are used as the identification information on the respective clients 12. The request source process ID item is an area for storing the ID of a process of issuing a request for a CAD function, which is a process performed by the client 12 that issues the request for the CAD function. The application server item is an area for storing information that identifies the application server 21 to which the request source client is initially connected or the application servers 21 that lastly implements the CAD function. The application server process ID item is an area for storing the ID of the process of lastly implementing the CAD function, which is the process performed by the application server 21 that lastly implements the CAD function requested by the client 12. The in-use CAD function item is an area for storing the CAD function that is lastly implemented by the application server 21 in response to a request from the client 12.

The FIG. 5 example represents that the process of the process ID “XXXX” performed by the client 12A requests the function of “Editing 1”, the function is implemented by the process of the process ID “XXXX” performed by the application server 21, and the turnaround time is “0.5”. It is also represented that the process of the process ID “XXXX” performed by the client 12B requests the function of “Edition M”, the function is implemented by the process of the process ID “XXXX” performed by the application server 21B, and the turnaround time is “1”. It is also represented t the process of the process ID “XXXX” performed by the client 12C requests the function of “Analysis 1”, the function is implemented by the process of the process ID “XXXX” performed by the application server 21C, and the turnaround time is “1”.

The following description refers back to FIG. 2. The controller 32 is a device that controls the request distribution apparatus 20. For the controller 32, an electronic circuit, such as a central processing unit (CPU) or a micro processing unit (MPU), or an integrated circuit, such as an application specific integrated circuit (ASIC) or a field programmable gate array (FPGA), can be used. The controller 32 includes an internal memory for storing programs that define various procedures and control data, and the controller 32 performs various types of processing according to the programs and control data. The various programs run and accordingly the controller 32 functions as various processors. For example, the controller 32 includes a receiver 50, a hardware specifying unit 51, a server specifying unit 52, a selecting unit 53, a transfer unit 54, and a transmitter 55.

The receiver 50 is a processor that receivers various requests. For example, the receiver 50 receives requests regarding various CAD functions that are transmitted from the client 12. The receiver 50 specifies the source of the request from the received request. For example, the receiver 50 specifies the client 12, i.e., the source of the request, and the process from the IP address and the port number that are contained in the packet data of the received request. When the data of the received request contains identification information indicating the client 12, i.e., the request source, and the process, the receiver 50 may specify the client 12, i.e., the request source, and the process from the identification information.

The hardware specifying unit 51 is a processor that specifies the hardware to be used to implement the requested function. For example, when the receiver 50 receives a request regarding a CAD function, the hardware specifying unit 51 specifies the hardware to be used to implement the received CAD function on the basis of the function information 40. For example, the hardware specifying unit 51 reads the data of the GPU and GPGPU items of the record corresponding to the received CAD function and determines whether to use a GPU and GPGPU to implement the received CAD function.

The server specifying unit 52 is a processor that specifies the application server 21 that processes the request from the client 12. For example, the server specifying unit 52 specifies the application server 21 that processes the request from the client 12 that transmits the request. For example, the server specifying unit 52 reads the record corresponding to the client 12 that transmits the request from the request source information 42 and the server specifying unit 52 specifies the application server 21 that processes the request of the client 12 from the application server item.

The selecting unit 53 is a processor that selects an application server 21 to be caused to implement the requested function. For example, the selecting unit 53 determines, on the basis of the server information 41, whether the application server 21 that is specified by the server specifying unit 52 includes the hardware that is specified by the hardware specifying unit 51. For example, the selecting unit 53 reads, from the server information 41, the record of the application server 21 specified by the server specifying unit 52 and determines, from the data of the GPU and GPGPU items of the assistance item, whether the application server 21 includes the hardware to be used to implement the requested CAD function. The selecting unit 53 determines whether the hardware to be used to implement the requested CAD function is in use from the data of the GPU and GPGPU items of the assistance use state item.

When the application server 21 that is specified by the server specifying unit 52 includes the hardware to be used to implement the requested CAD function and the hardware is not in use, the selecting unit 53 selects the application server 21 as the application server 21 to be caused to implement the CAD function.

On the other hand, when the application server 21 that is specified by the server specifying unit 52 does not include the hardware to be used to implement the requested CAD function or the hardware is in use, the selecting unit 53 selects another application server 21. For example, the selecting unit 53 selects, from among the multiple application servers 21, an application server 21 including the hardware that is specified by the hardware specifying unit 51 and that is not in use. For example, the selecting unit 53 extracts, from among the multiple application servers 21 that are stored in the server information 41, application servers 21 that include the hardware that is specified by the hardware specifying unit 51 and that is not in use. The selecting unit 53 then selects an application server 21 to be caused to implement the requested CAD function from among the extracted application servers 21. The selecting unit 53 selects an application server 21 where the number of requests being processed does not exceed the maximum processed-request number. When multiple application servers 21 are selected, the selecting unit 53 selects an application server 21 that has the best processing performance for implementing the requested CAD function.

When the application server 21 that is specified by the server specifying unit 52 does not include the hardware to be used to implement the requested CAD function, the application server 21 is an application server 21 that is not suitable to implement the requested CAD function. For this reason, the selecting unit 53 selects another application server 21 including the hardware that is specified by the hardware specifying unit 51 and that is not in use.

The transfer unit 54 is a processor that transfers the application server 21 that processes the request from the client 12. For example, when the application server 21 that is specified by the server specifying unit 52 does not include the hardware to be used to implement the requested CAD function, the transfer unit 54 transfers the design environment of the specified application server 21 to another application server 21 that is selected by the selecting unit 53.

When the number of requests being processed by the application server 21 selected by the selecting unit 53 exceeds the maximum processed-request number, the transfer unit 54 transfers the processing environment in which any one of the requests is processed to another application server 21. The processing environment refers to information and software that are necessary for the application server 21 to process the request by the application server 21. The processing environment is transferred to another application server 21 and is caused to run so that the application server 21 enters a state where the requested processing can be performed.

The transmitter 55 is a processor that transmits, to the application server 21, the request that is received by the receiver 50. For example, the transmitter 55 transmits a request regarding a CAD function, which is the request received by the receiver 50, to an application server 21 that is selected by the selecting unit 53. Accordingly, the request regarding the CAD function is transmitted to the application server 21 that includes the hardware to be used to implement the CAD function.

System Operations

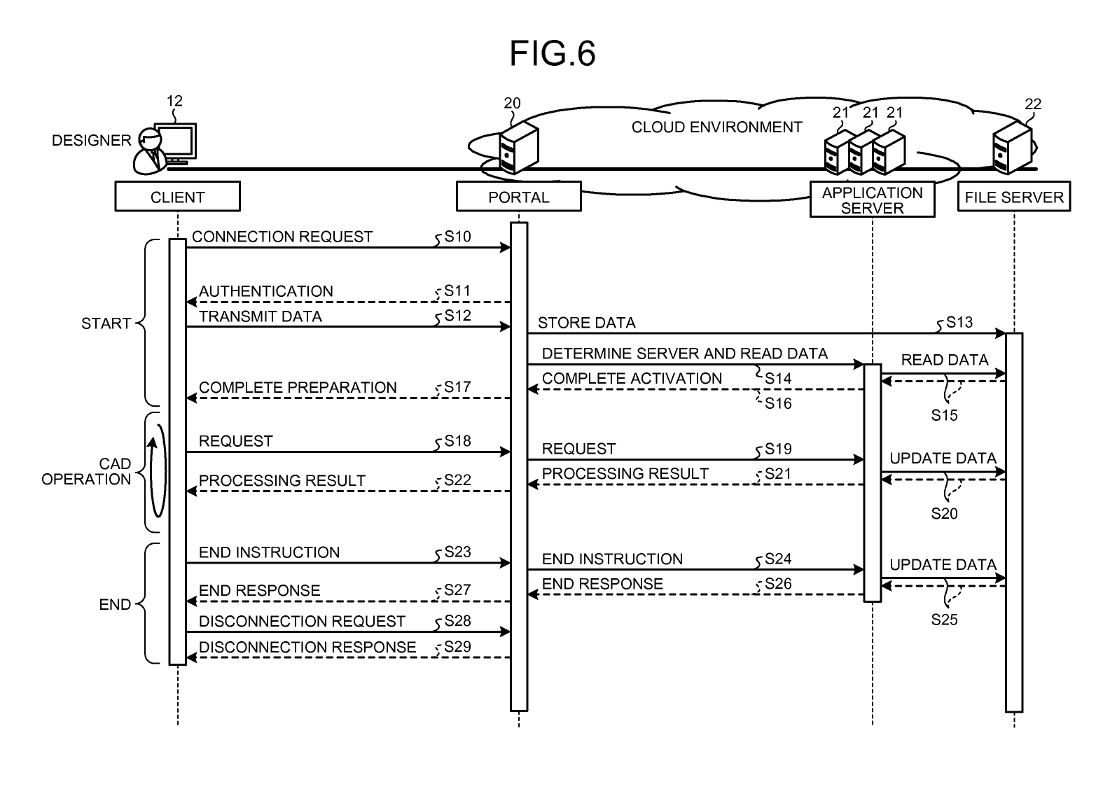

The processing operations of the system 10 according to the first embodiment will be described here. First, the general operations performed by the system 10 according to the embodiment to perform circuit designing will be described. FIG. 6 is a sequence diagram of exemplary general operations of the system.

The designer accesses the request distribution apparatus 20, using the client 12, to request a connection (step S10). The request distribution apparatus 20, for example, displays a login screen to cause a user to input the ID, password, etc. and determines whether the user is authentic. Upon authenticating the user, the request distribution apparatus 20 makes a notification indicating that the user is authenticated (step S11) so that the design assist services are available.

Using the client 12, the designer transmits various types of information used for circuit designing to the request distribution apparatus 20 (step S12). For example, the designer transmits design data under designing etc. to the request distribution apparatus 20. The request distribution apparatus 20 stores the received various types of information in association with the designer in the file server 22 (step S13). The request distribution apparatus 20 determines an application server 21 to be used for circuit designing. The application server 21 used for circuit designing may be specified by the designer. The application server 21 used for circuit designing may be automatically determined by the request distribution apparatus 20 according to given rules. For example, the request distribution apparatus 20 may randomly determine the application server 21 to be used for circuit designing. The request distribution apparatus 20 may determine, as the application server 21 to be used for circuit designing, an application server 21 where the value obtained by subtracting the number of requests being processed from the maximum processed-request number is the largest. The request distribution apparatus 20 may determine an application server 21 to be used for circuit designing according to a predetermined order. The application server item of the request source information 42 stores, as the initial connection destination, information that identifies the determined application server 21. The request distribution apparatus 20 issues, to the determined application server 21, an instruction for activating the CAD program and reading the data of the designer (step S14).

The application server 21 starts the CAD program according to the instruction from the request distribution apparatus 20 and reads the data of the designer from the file server 22 (step S15). Thus, the application server 21 builds a design environment where the designer performs circuit designing. Once the design environment is built and the activation completes, the application server 21 notifies the request distribution apparatus 20 of the completion of the activation (step S16). The application server 21 generates image information representing the design environment and transmits the image information to the request distribution apparatus 20.

Upon being notified by the application server 21 of the completion of the activation, the request distribution apparatus 20 notifies the client 12 of the preparation completion (step S17) and transmits the image information, which is received from the application server 21, to the client 12. Accordingly, a design environment screen is displayed on the client 12.

Using the client 12, the designer performs various operations regarding circuit designing. The client 12 transmits various requests regarding CAD functions to the request distribution apparatus 20 according to the accepted operations (step S18).

Upon accepting a request from the client 12, the request distribution apparatus 20 transmits the request to the application server 21 where the design environment of the client 12 is built (step S19). The application server 21 performs processing according to the received request and updates the data of the designer that is stored in the file server 22 (step S20). The application server 21 generates processing result information, such as image information representing the result of the processing, and transmits the processing result information to the request distribution apparatus 20 (step S21). The request distribution apparatus 20 transmits the process result information, such as the image information, received from the application server to the client 12 that transmits the request (step S22). Accordingly, a screen displaying the result of implementing the requested function is displayed on the client 12.

Each time the designer performs various operations regarding circuit designing using the client 12, the above-described steps S18 to S22 are repeated.

When ending circuit designing, the designer operates the client 12 to issue an instruction for ending circuit designing. The client 12 transmits the end instruction to the request distribution apparatus 20 (step S23).

Upon accepting the end instruction from the client 12, the request distribution apparatus 20 transmits the end instruction to the application server 21 where the design environment of the client 12 is built (step S24). Upon accepting the store instruction, the application server 21 stores the data of the designer in the file server 22 (step S25). Once storing of the data completes, the application server 21 ends the CAD program, frees the design environment, and transmits a response indicating that the processing ends to the request distribution apparatus 20 (step S26). Upon receiving the response indicating that the processing ends from the application server 21, the request distribution apparatus 20 transmits the response indicating that the processing ends to the client 12 (step S27). Upon receiving the response indicating that the processing ends from the request distribution apparatus 20, the client 12 transmits a disconnection request to the request distribution apparatus (step S28) and, upon receiving a response to the disconnection request from the request distribution apparatus 20 (step S29), ends the process.

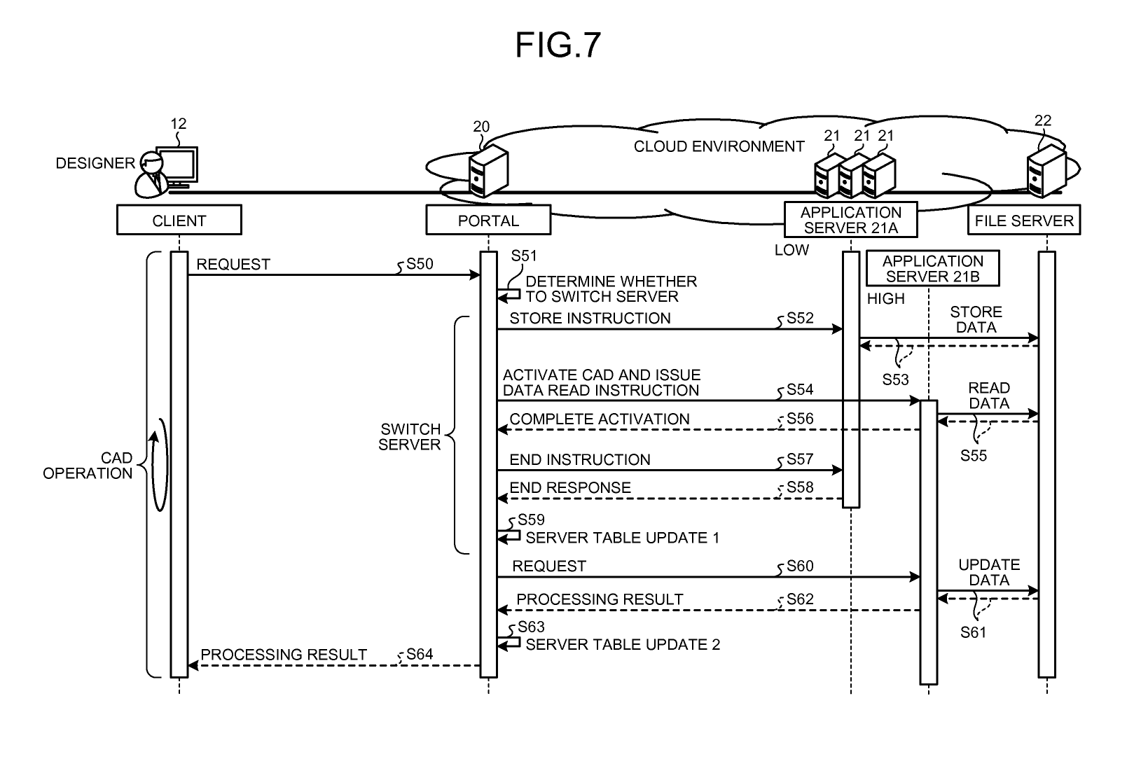

Detailed operations performed when the client 12 performs operations regarding circuit designing will be described here. FIG. 7 is a sequence diagram of exemplary detailed operations of the system. FIG. 7 illustrates the processing operations from steps S18 to S22 illustrated in FIG. 6 more in detail.

Using the client 12, the operator performs various operations regarding circuit designing. The client 12 transmits various requests regarding CAD functions to the request distribution apparatus 20 according to the accepted operations (step S50).

The request distribution apparatus 20 determines whether to switch the application server 21 according to whether the application server 21 with the design environment of the client 12 includes the hardware to be used to implement the requested function (step S51).

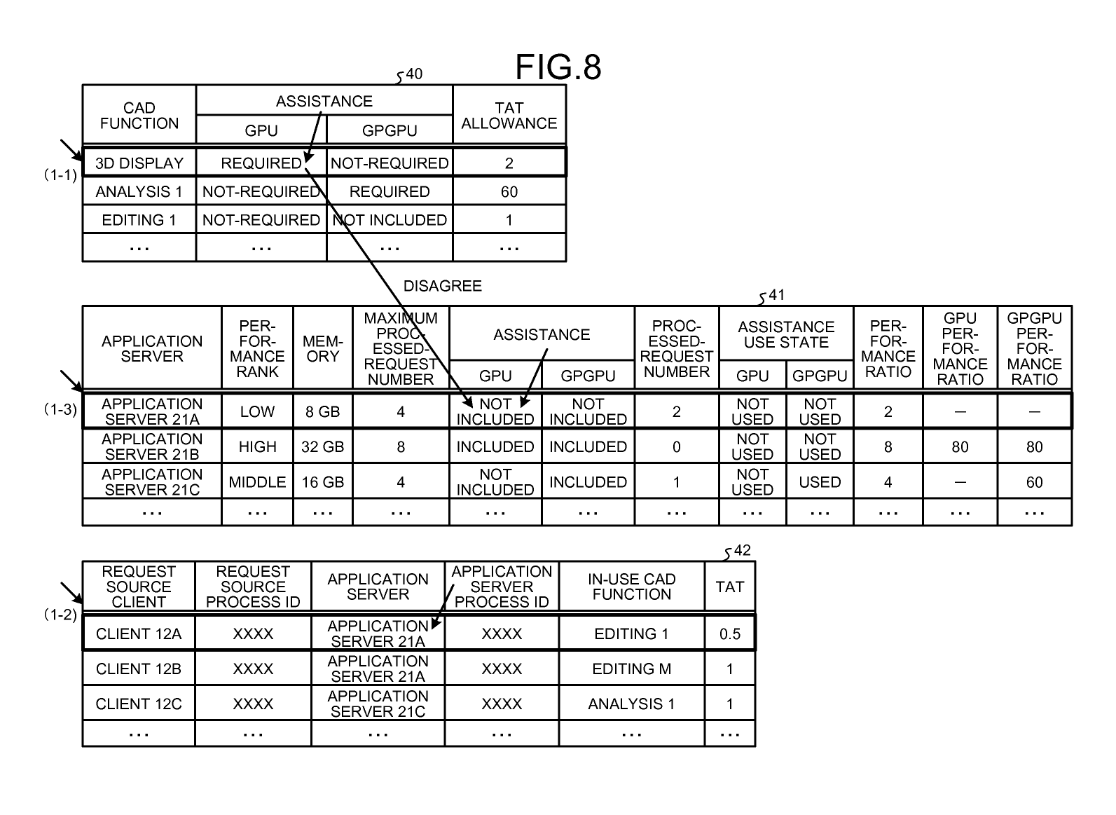

FIG. 8 illustrates the flow of processing for determining whether to switch an application server. For example, when a 3D display request is accepted as a request regarding a CAD function from the client 12A, the hardware specifying unit 51 specifies, from the function information 40, that the hardware to be used to implement the 3D display function is a GPU ((1-1) in FIG. 8). The server specifying unit 52 specifies, from the request source information 42, the application server 21 with the design environment of the client 12A as the application server 21A ((1-2) in FIG. 8). The selecting unit 53 reads the record of the application server 21A from the server information 41 and determines whether the application server 21A includes a GPU from the data of the GPU item of the assistance item. The selecting unit 53 determines whether the GPU is in use from the data of the GPU item of the assistance use state item ((1-3) in FIG. 8).

When the application server 21A includes a GPU and the GPU is not in use, the selecting unit 53 selects the application server 21A as the application server 21 to be caused to implement the requested CAD function.

On the other hand, when the application server 21A includes no GPU or when the GPU is in use, the selecting unit 53 determines to switch the application server 21. In the FIG. 8 example, while “required” is set for the GPU item of the function information 40, “not-included” is set for the GPU item of the assistance item of the server information 41, i.e., the application server 21A includes no GPU. Accordingly, in the FIG. 8 example, it is determined to switch the application server 21.

When determining to switch the application server 21, the selecting unit 53 selects, from among the multiple application servers 21, an application server including the hardware that is specified by the hardware specifying unit 51 and that is not in use.

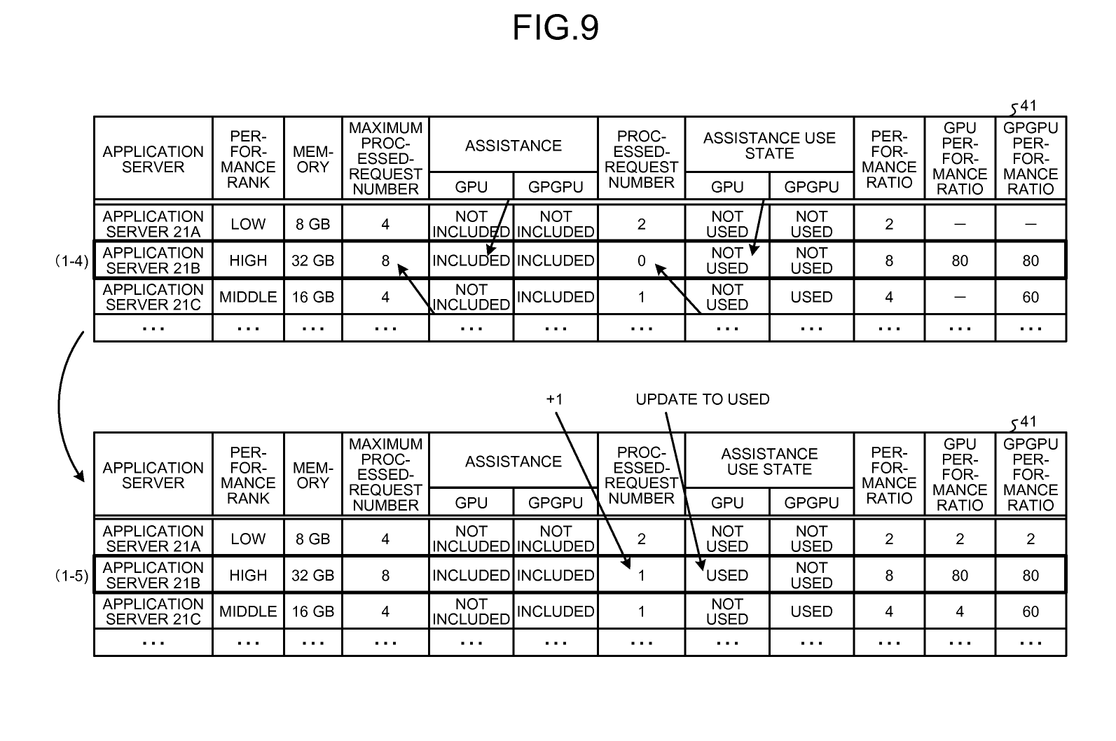

FIG. 9 illustrates the flow of processing for selecting an application server to which the application server is switched. For example, the selecting unit 53 extracts, from among the multiple application servers 21 stored in the server information 41, an application server 21 including the hardware that is specified by the hardware specifying unit 51 and that is not in use. The selecting unit 53 then selects an application server 21 where the number of requests being processed does not exceed the maximum processed-request number. In the FIG. 9 example, the application server 21B is selected because the application server 21B includes a GPU, the GPU is not in use, and the processed-request number does not exceed the maximum processed-request number ((1-4) in FIG. 9).

The selecting unit 53 updates the processed-request number item and the assistance use state item of the server information 41 in order to cause the selected application server 21 to implement the requested CAD function. For example, the selecting unit 53 updates the processed-request number item of the record of the selected application server 21 in the server information 41 to the value obtained by adding 1 to the value of the processed-request number item. Furthermore, the selecting unit 53 updates the GPU item of the assistance use state item of the record of the selected application server 21 in the server information to “used” indicating that the GPU is in use ((1-5) in FIG. 9).

The following description refers back to FIG. 7. When it is determined to switch the application server 21, the transfer unit 54 transfers the design environment of the application server 21 that is specified by the server specifying unit 52 to the application server 21 that is selected by the selecting unit 53. In the FIG. 7 example, the transfer unit 54 transfers the design environment from the application server 21A to the application server 21B. For example, the transfer unit 54 transmits a store instruction to the application server 21A (step S52). Upon accepting the store instruction, the application server 21A stores various types of information regarding the design environment in the file server 22 (step S53).

The transfer unit 54 gives, to the application server 21B, an instruction for activating the CAD program and for reading various types of information regarding the design environment (step S54). According to the instruction from the request distribution apparatus 20, the application server 21B activates the CAD program and reads the various types of information regarding the design environment from the file server 22 (step S55). Accordingly, the design environment is transferred from the application server 21A to the application server 21B. Once the design environment is built in the application server 21B and when the activation completes, the application server 21B notifies the request distribution apparatus 20 of the completion of the activation (step S56). Upon being notified of the completion of the activation by the application server 21B to which the design environment is transferred, the transfer unit 54 transmits an end instruction to the application server 21A from which the design environment is transferred (step S57). Upon accepting the end instruction, the application server 21A ends the AD program, frees the design environment, and transmits a response indicating that the processing ends to the request distribution apparatus 20 (step S58).

The application server 21A ends and accordingly the transfer unit 54 updates the server information 41 (step S59).

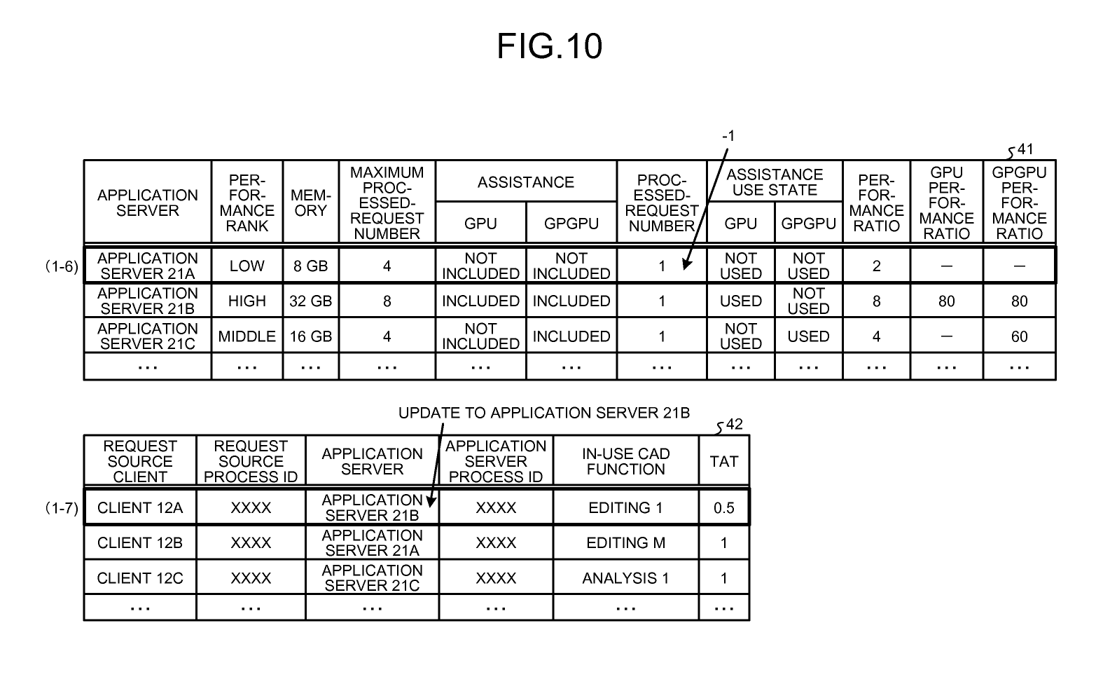

FIG. 10 illustrates the flow of processing for updating the server information. For example, the selecting unit 53 updates the value of the processed-request number item of the record of the application server 21A in the server information 41 to the value obtained by subtracting 1 from the value of the processed-request number item ((1-6) in FIG. 10). The selecting unit 53 also updates the application server item of the client 12A in the request source information 42 to the application server 21B ((1-7) in FIG. 10).

The following description refers back to FIG. 7. The transmitter 55 transmits, to the application server 21 selected by the selecting unit 53, a request regarding a CAD function that is received by the receiver 50 (step S60). In the FIG. 7 example, the transmitter 55 transmits the request regarding the CAD function to the application server 21B. The application server 21B performs processing according to the received request and updates the data of the designer that is stored in the file server 22 (step S61). The application server 21B then generates processing result information, such as image information representing the result of the processing, and transmits the processing result information to the request distribution apparatus 20 (step S62).

The application server 21 ends performing the requested processing and accordingly the transmitter 55 updates the request source information 42 (step S63).

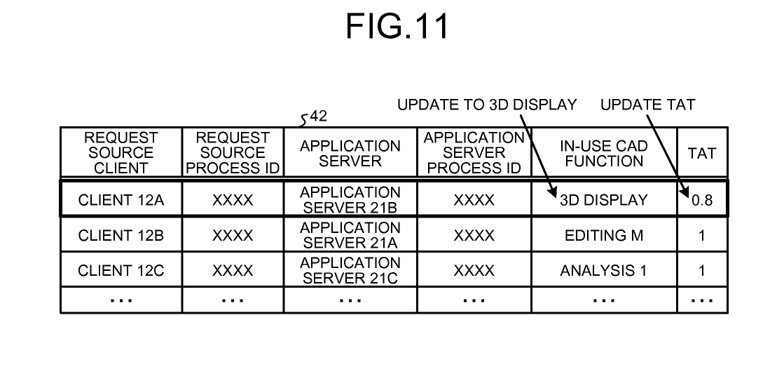

FIG. 11 illustrates the flow of processing for updating the request source information. For example, the transmitter 55 updates the in-use CAD function item of the record of the client 12A in the request source information 42 to the requested 3D display. The transmitter 55 updates the TAT item to a time after the request is received until the response to the request is made.

The following description refers back to FIG. 7. The request distribution apparatus 20 transmits the processing result information, such as the image information, received from the application server 21 to the client 12 that transmits the request (step S64).

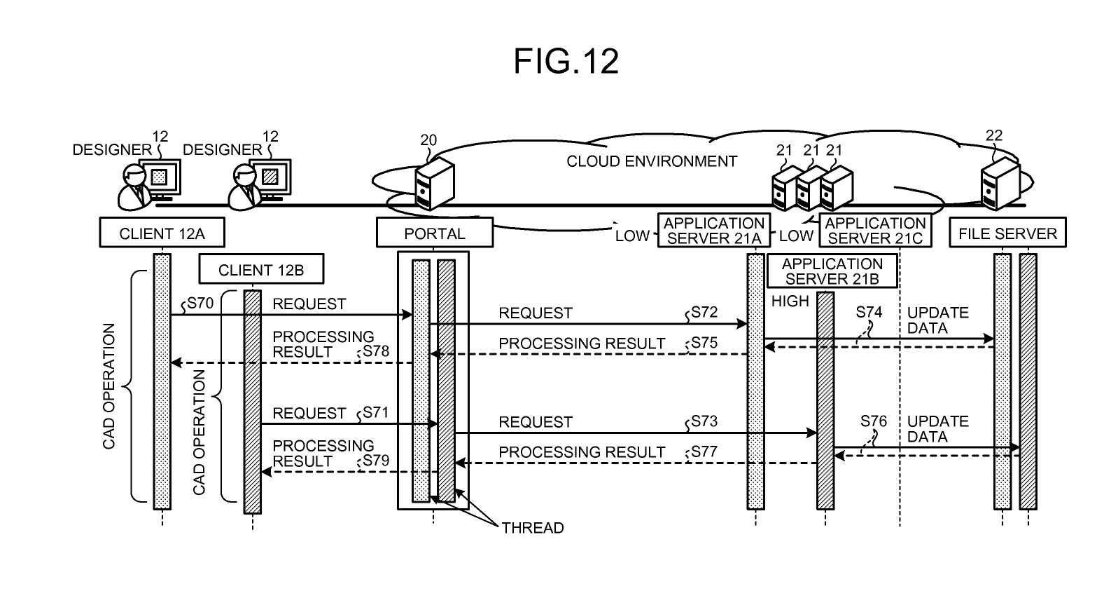

The processing operations performed when multiple clients 12 perform circuit designing will be described here. FIG. 12 is a sequence diagram of exemplary general operations of the system that are performed when multiple clients perform circuit designing. For the FIG. 12 example, a case will be described where the clients 12A and 12B perform operations regarding circuit designing. In the FIG. 12 example, patterns are illustrated separately such that the threads where the clients 12A and 12B perform the processing corresponding to the request can be distinguished from each other.

Each of the clients 12A and 12B accepts various operations regarding circuit designing from the designer. The clients 12A and 12B transmit various requests regarding CAD functions according to the accepted operations. For example, the client 12A transmits a request to the request distribution apparatus 20 according to the accepted operation (step S70). The client 12B transmits a request to the request distribution apparatus 20 according to the accepted operation (S71).

Upon accepting a request from a client 12, the request distribution apparatus 20 transmits the request to an application server 21 where the design environment of the client 12 is built. For example, upon accepting a request from the client 12A, the request distribution apparatus 20 transmits the request to the application server 21A (step S72). Upon accepting a request from the client 12B, the request distribution apparatus 20 transmits the request to the application server 21B (step S73).

The application server 21A performs processing according to the request from the client 12A and updates the data of the designer that is stored in the file server (step S74). The application server 21A generates processing result information, such as image information representing the result of the processing, and transmits the processing result information to the request distribution apparatus 20 (step S75). The application server 21B performs processing according to the request from the client 12B and updates the data of the designer that is stored in the file server 22 (step S76). The application server 21B generates processing result information, such as image information representing the result of the processing, and transmits the processing result information to the request distribution apparatus 20 (step S77).

The request distribution apparatus 20 transmits the processing result information, such as image information, that is received from the application server 21A to the client 12A that transmits the request (step S78). The request distribution apparatus 20 transmits the processing result information, such as image information, that is received from the application server 21B to the client 12B that transmits the request (step S79).

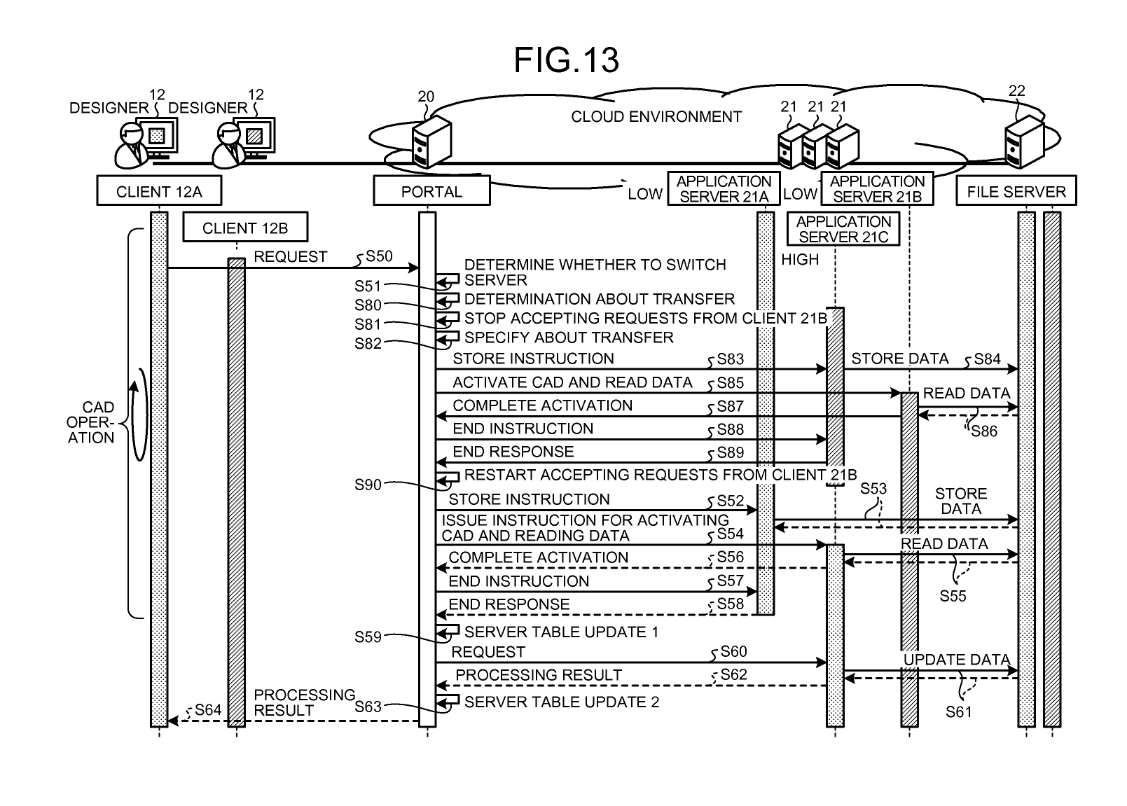

Detailed operations of the system performed when multiple clients 12 perform circuit designing will be described here. FIG. 13 is a sequence diagram of exemplary detailed operations of the system that are performed when multiple clients perform circuit designing. Descriptions for the same processing as that illustrated in FIG. 7 are partly omitted by denoting the processing with the same reference numerals as those in FIG. 7.

Using the client 12A, the designer performs various operations regarding circuit designing. The client 12A transmits various requests regarding CAD functions to the request distribution apparatus 20 according to the accepted operations (step S50).

The request distribution apparatus 20 determines whether to switch the application server 21A according to whether the application server 21A with the design environment of the client 12, in which the request is processed, includes the hardware to be used to implement the requested function (S51). Here, the selecting unit 53 determines to switch the application server 21A and selects the application server 21B as the application server to which the application server 21A is switched. The selecting unit 53 updates the processed-request number item and the assistance use state item in the server information 41 in order to cause the selected application server 21B to implement the requested CAD function.

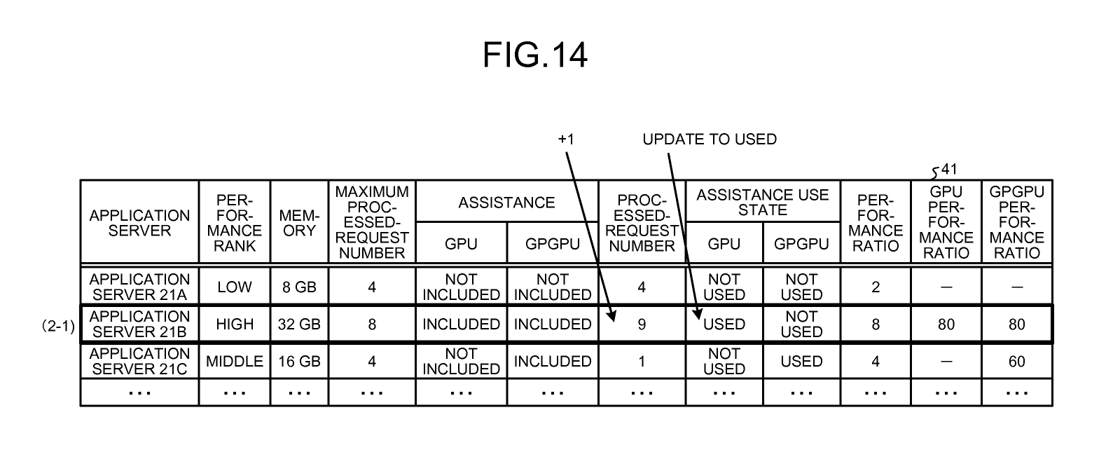

FIG. 14 illustrates a flow of processing for updating the server information. For example, the selecting unit 53 updates the processed-request number item of the record of the application server 21B to the value obtained by adding 1 to the value of the processed-request number item. Furthermore, the selecting unit 53 updates the GPU item of the assistance use state item of the record of the selected application server 21B in the server information 41 to “used” indicating that the GPU is in use ((2-1) in FIG. 14).

The following description refers back to FIG. 13. The transfer unit 54 determines whether there is an application server 21 whose design environment should be transferred (step S80). For example, the transfer unit 54 determines whether there is an application server 21 where the processed-request number exceeds the maximum processed-request number. When there is an application server 21 where the processed-request number exceeds the maximum processed-request number from among the application servers 21 that are selected by the selecting unit 53, the transfer unit 54 determines that there is an application server 21 whose design environment should be transferred and transfers the processing environment in which any one of the requests is processed to a different application server 21.

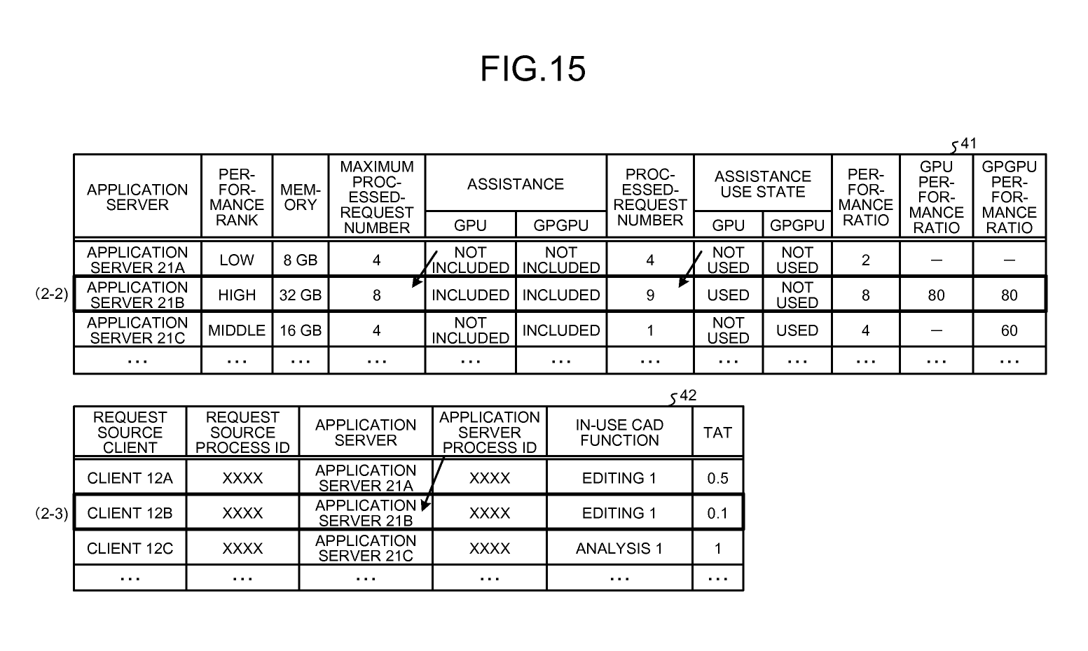

FIG. 15 illustrates a flow of processing for determining whether to transfer the design environment of any one of the application servers. Regarding the application server 21B, the value of the processed-request number in the server information 41 is larger than the value of the maximum processed-request number item. In this case, the transfer unit 54 determines the application server 21B as an application server 21 whose design environment should be transferred (FIG. 15 (2-2)).

The following description refers back to FIG. 13. The transfer unit 54 stops accepting requests from the client 12A (S81).

The transfer unit 54 extracts all clients 12 to which the application server 21B provides the design environment. For example, the transfer unit 54 extracts all records of the application servers 21 whose design environment should be transferred from the request source information 42. For example, in the FIG. 15 example, the record where the application server item represents the application server 21B is extracted from the request source information 42 ((2-3) in FIG. 15). The transfer unit 54 sorts the extracted records according to the ascending order of TAT.

The transfer unit 54 selects records according to the ascending order of TAT and specifies an application server 21 to which design environment can be transferred (S82).

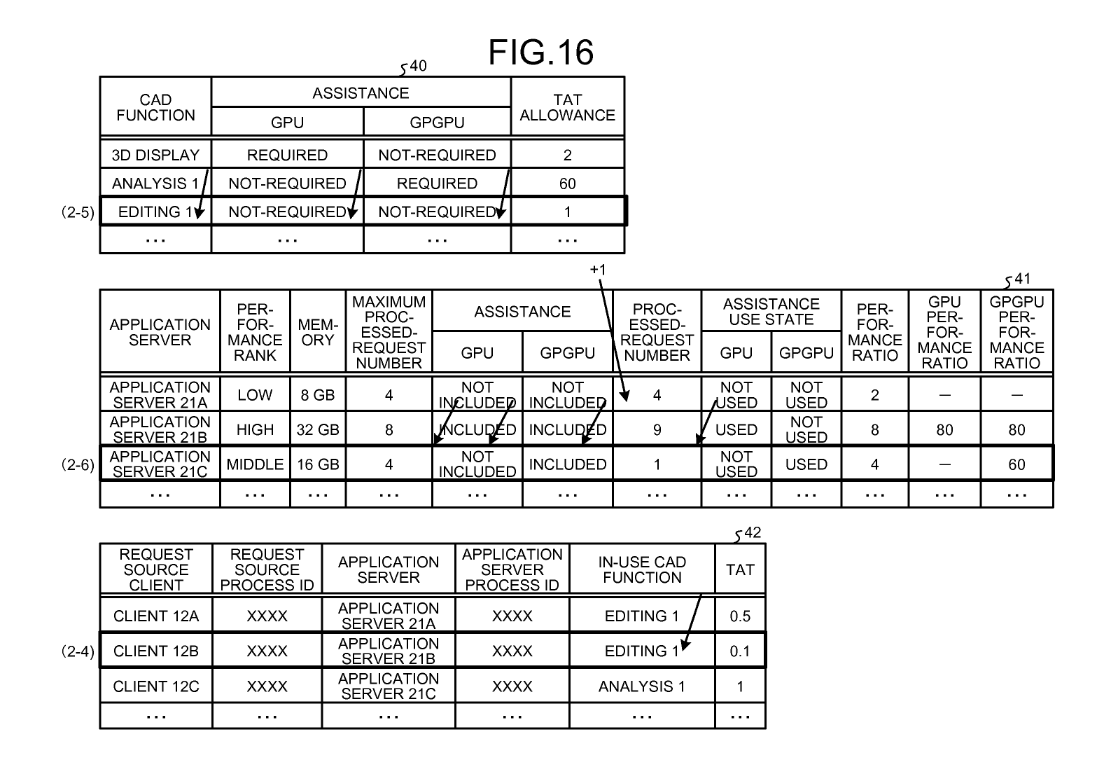

FIG. 16 illustrates a flow of processing for determining whether it is possible to transfer the design environment. The transfer unit 54 refers to the in-use CAD function item of the selected record and specifies the requested CAD function. For example, upon selecting the record denoted by (2-4) in FIG. 16, the transfer unit 54 specifies Editing 1 as the requested CAD function.

The transfer unit 54 searches for another application server 21 that can implement the specified CAD function. For example, the transfer unit 54 specifies hardware to be used to implement the specified CAD function. For example, when the specified CAD function is Editing 1, the transfer unit 54 specifies that there is no particular hardware to be used to implement the function of Editing 1 ((2-5) in FIG. 16). The transfer unit 54 searches for, from the server information 41, an application server 21 including hardware that is to be used to implement the specified CAD function and that is not in use. For example, because there is no particular hardware to be used to implement the function of Editing 1, the transfer unit 54 searches for, for example, the application server 21C ((2-6) in FIG. 16).

The transfer unit 54 determines whether the number of requests processed by the searched application server 21 is smaller than the maximum processed-request number. When the processed-request number is smaller than the maximum processed-request number, the transfer unit 54 estimates the performance implemented when the searched application server 21 implements the specified CAD function. For example, the transfer unit 54 performs operations of dividing the performance ratio of the application server 21 from which design environment should be transferred by the performance ratio of the searched application server 21 to which the design environment is to be transferred and multiplying the value resulting from the division by the TAT of the specified CAD function. When the value resulting from the operations is within the value of the TAT allowance of the specified CAD function, which is the allowance stored in the function information 40, the transfer unit 54 determines the application server 21 as the application server 21 to which design environment can be transferred. For example, when transferring the design environment from the application server 21B to the application server 21C, the transfer unit 54 divides the performance ratio “8” of the application server 21B illustrated in FIG. 16 by the performance ratio “4” of the application server 21C. The transfer unit 54 then performs an operation of multiplying the value “0.5” resulting from the division by the TAT of “0.1” for implementing the function of Editing 1 that is stored in the request source information 42. The value “0.2” resulting from the operation is within the value “1” of the TAT allowance item of the Editing 1 function that is stored in the function information 40. For this reason, the application server 21C is specified as an application server 21 to which the design environment can be transferred. When the hardware to be used to implement the CAD function to be transferred includes a GPU, the transfer unit 54 gives an estimate using the GPU performance ratio. When the hardware to be used to implement the CAD function to be transferred includes a GPGPU, the transfer unit 54 gives an estimate using the GPGPU performance ratio.

The following description refers back to FIG. 13. The transfer unit 54 transfers the specified CAD function to the application server 21 to which the design environment can be transferred. For example, the transfer unit 54 transfers the design environment of the client 12B from the application server 21B to the application server 21C. For example, the transfer unit 54 transmits a store instruction to the application server 21B (step S83). Upon accepting the store instruction, the application server 21B stores various types of information regarding the design environment in the file server 22 (step S84).

The transfer unit 54 gives, to the application server 21C, an instruction for activating the CAD program and reading various types of information regarding the design environment to be transferred (step S85). The application server 21C activates the CAD program according to the instruction and reads various types of information regarding the design environment to be transferred from the file server 22 (step S86). Accordingly, the design environment is transferred from the application server 21B to the application server 21C. Once the design environment is built and the activation completes, the application server 21C notifies the request distribution apparatus 20 of the completion of the activation (step S87). Upon being notified of the completion of the activation by the application server 21C to which the design environment is transferred, the transfer unit 54 gives an end instruction to the application server 21B from which the design environment is transferred (step S88). Upon receiving the end instruction, the application server 21B frees the design environment and transmits a response indicating that the processing ends to the request distribution apparatus (step S89).

The transfer unit 54 then restarts accepting requests from the client 12A (step S90). The transfer unit 54 updates the server information 41.

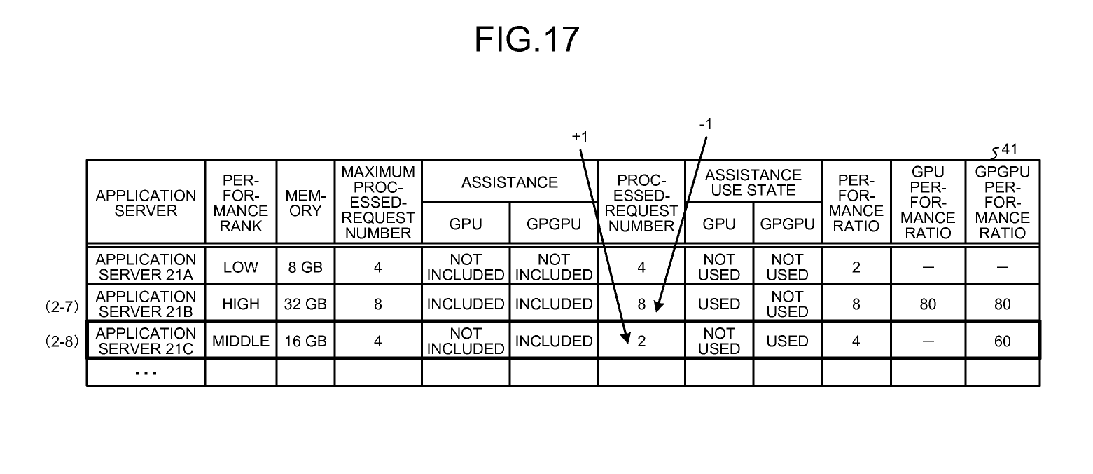

FIG. 17 illustrates a flow of processing for updating the server information. For example, the transfer unit 54 updates the value of the processed-request number item of the record of the application server 21B in the server information 41 to the value obtained by subtracting 1 from the value ((2-7) in FIG. 17). The transfer unit 54 also updates the value of the processed-request number item of the record of the application server 21C in the server information 41 to the value obtained by adding 1 to the value ((2-8) in FIG. 17). Furthermore, the transfer unit 54 updates the value of the application server item of the client 12 in the request source information 42 to the application server 21C.

According to the same processing as that at steps S52 to S63, the transfer unit 54 then transfers the design environment from the application server 21A to the application server 21B.

Processing Flow

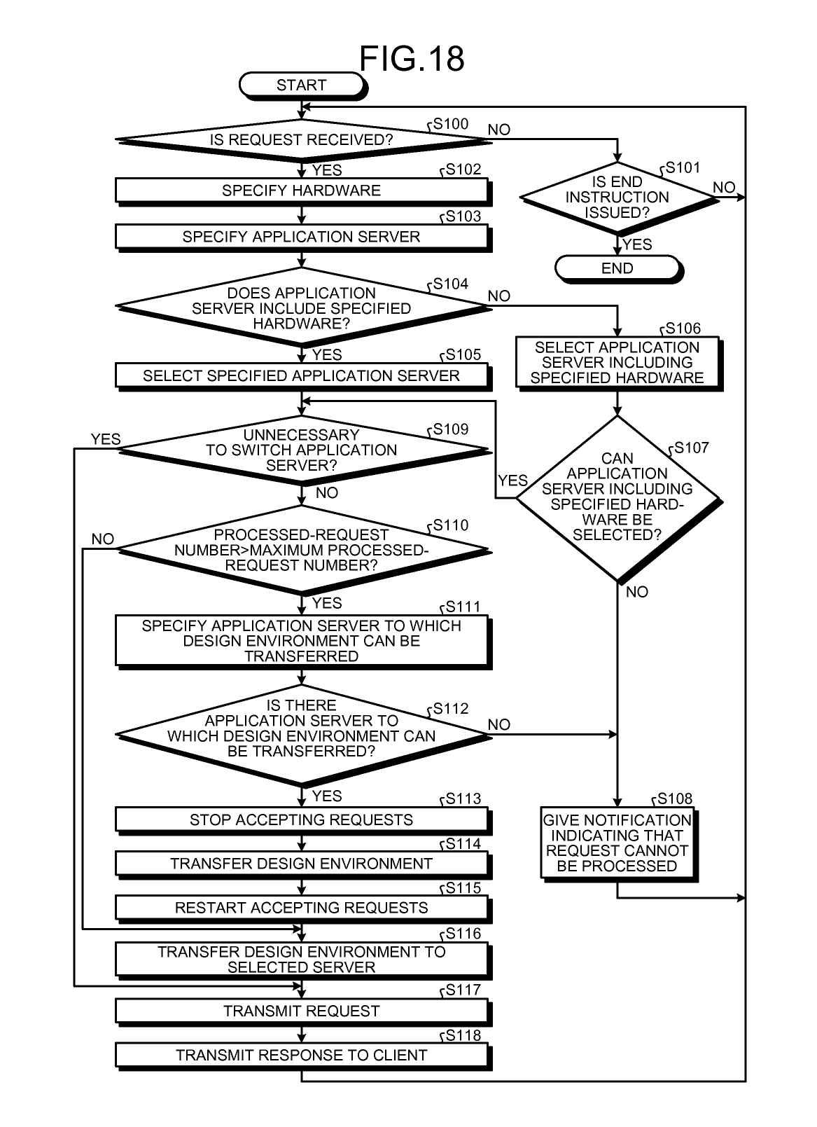

The flow of request distribution processing for distributing requests that is performed by the request distribution apparatus 20 will be described here. FIG. 18 is a flowchart of an exemplary procedure of the request distribution processing. The request distribution processing is performed at a given timing, e.g., a timing when the request distribution apparatus 20 is activated, after the request distribution apparatus 20 is activated, a timing when a request is received for the first time, or a timing when a management terminal, etc. issues an execution instruction.

As illustrated in FIG. 18, the receiver 50 determines whether any request regarding various CAD functions is received from a client 12 (step S100). When not any request has been received (NO at step S100), the receiver 50 determines whether an instruction for ending the processing is issued (NO at step S101). When not any instruction for ending the processing is issued (NO at step S101), the procedure goes to step S100. On the other hand, an instruction for ending the processing is issued (YES at step S101), the processing is ended.

On the other hand, when a request is received (YES at step S100), the hardware specifying unit 51 reads a record corresponding to the received CAD function from the function information 40 and specifies hardware to be used to implement the requested function (step S102). The server specifying unit 52 reads, from the request source information 42, the record corresponding to the client 12 that transmits the request and specifies an application server 21 to process the request (step S103).

On the basis of the server information 41, the selecting unit 53 determines whether the specified application server 21 includes the specified hardware (step S104). When the specified application server 21 includes the specified hardware (YES at step S104), the selecting unit 53 selects the specified application server 21 as an application server 21 to be caused to implement the requested CAD function (step S105) and the procedure goes to step S107.

On the other hand, when the specified application server 21 does not include the specified hardware (NO at step S104), the selecting unit selects an application server 21 including the specified hardware that is not in use as the application server 21 to be caused to implement the requested CAD function (step S106). The transfer unit 54 determines whether an application server 21 that includes the specified hardware can be selected (step S107). When no application server 21 that includes the specified hardware is selected (NO at step S107), the transfer unit 54 transmits, to the client 12 that transmits the request, information indicating that there is no application server 21 suitable to implement the requested CAD function (step S108) and the procedure goes to step S100.

On the other hand, when such an application server 21 can be selected (step S105 or YES at step S107), the transfer unit 54 determines whether it is unnecessary to switch the application server 21 (step S109). For example, when the selected application server 21 is an application server 21 that has the design environment of the client 12 that transmits the request, the transfer unit 54 determines that it is unnecessary to switch the application server 21. When it is unnecessary to switch the application server 21 (YES at step S109), the procedure goes to step S117.

On the other hand, when it is not unnecessary to switch the application server 21 (NO at step S109), the transfer unit 54 determines whether the number of requests being processed by the selected application server 21 is larger than the maximum processed-request number (step S110). When the processed-request number is equal to or smaller than the maximum processed-request number (NO at step S110), the procedure goes to step S116, which will be described below.

When the processed-request number is larger than the maximum processed-request number (YES at step S110), the transfer unit 54 specifies an application server 21 to which the design environment can be transferred (step S111). The transfer unit 54 determines whether an application server 21 to which the design environment can be transferred is specified (step S112). When not any application server 21 to which the design environment can be transferred is specified (NO at step S112), the procedure goes to step S108.

On the other hand, when an application server 21 to which the design environment can be transferred is specified (YES at step S112), the transfer unit 54 temporarily stops accepting requests (step S113). The transfer unit 54 then transfers the design environment of the application server 21 to which the design environment can be transferred to the selected application server 21 (step S114). The transfer unit 54 then restarts accepting requests (step S115).

The transfer unit 54 transfers the design environment of the specified application server 21 to a selected application server 21 (step S116). The transmitter 55 then transmits the received request to the selected application server 21 (step S117). Upon receiving image information indicating the response to the request from the application server 21, the transmitter 55 transmits the image information to the client 12 that transmits the request (step S118) and the procedure goes to step S100.

Effects

As described above, the request distribution apparatus 20 according to the first embodiment receives a request regarding a function that is implemented by an application server 21. On the basis of the function information 40 that associates one of multiple functions and hardware that is necessary to implement the function, the request distribution apparatus 20 specifies hardware necessary to implement the function requested by the received request. On the basis of the server information 41 that associates an application server 21 and the hardware of the application server 21, the request distribution apparatus 20 selects an application server 21 that includes the specified hardware from among multiple application servers 21. By selecting an application server 21 for the received request in this manner, the request distribution apparatus 20 can efficiently distribute processing to the application servers 21.

Furthermore, on the basis of the request source information 42 that associates a client 12 that is a request source of a request and an application server 21 that processes the last request from the client 12, the request distribution apparatus 20 according to the first embodiment specifies the application server 21 corresponding to the request source of the received request. When the specified application server 21 includes the specified hardware, the request distribution apparatus 20 selects the specified application server 21. When the specified application server 21 does not include the specified hardware, the request distribution apparatus 20 selects another application server 21 that includes the specified hardware. Accordingly, when the application server 21 corresponding to the source of the request includes the hardware to be used to implement the requested function, the request distribution apparatus 20 can cause the same application server 21 to process the request. When the application server 21 does not include the hardware to be used to implement the requested function, the request distribution apparatus 20 can distribute an application server 21 suitable to process the received request.

When the specified application server 21 does not include the specified hardware, the request distribution apparatus 20 according to the first embodiment transfers the processing environment of the specified application server 21 in which processing according to the received request is performed to another application server 21. Accordingly, the request distribution apparatus 20 can cause another application server 21 to process the request using the same processing environment.

When the number of requests from each request source being processed by the selected application server 21 exceeds a given threshold, the request distribution apparatus 20 according to the first embodiment transfers the processing environment in which a request other than the received request is processed to a different application server 21. Accordingly, the request distribution apparatus 20 can reduce the load of processing performed by the selected application server 21.

The request distribution apparatus 20 according to the first embodiment transfers, to a different application server 21, the processing environment corresponding to any one of the requests where a processing time in which the different application server 21 processes the request is within an allowable time for the request. Accordingly, the request distribution apparatus 20 can prevent that the processing time in which the different server processes the request is longer than the allowable time.

The request distribution apparatus 20 according to the first embodiment receives requests for CAD functions including 3D display and analysis, selects an application server 21 including a GPU for a 3D display request, and selects an application server 21 including a GPGPU for an analysis request. Accordingly, the request distribution apparatus 20 can distribute the CAD functions to application servers 21 that can comfortably implement the CAD functions.

### [b] Second Embodiment

The first embodiment of the disclosed apparatus has been described. In addition to the above-described embodiment, the disclosed technology can be implemented in various different modes. Other embodiments of the present invention will be described below.

For the above-described embodiment, the case has been described where circuit designing is performed by cloud computing. However, the disclosed apparatus is not limited to this. Any system may be used as long as it is determined which hardware is used to implement each requested function, servers with different types of servers are used, and received requests are distributed to the servers.

For the above-described embodiment, the case has been described where, on the basis of the function information 40 and the server information 41, an application server 21 that includes the hardware necessary to implement the function requested by the received request. However, the disclosed apparatus is not limited to this. For example, the function information 40 and the server information 41 may be integrated. For example, the storage unit 31 may store a table that associates one of multiple functions to be implemented by application servers 21 with an application server 21 that includes hardware necessary to implement the function. This table is an example of first information. In this case, on the basis of the table, the hardware specifying unit 51 may specify an application server 21 that implements the function requested by a received request. Accordingly, an application server 21 is selected for the received request and accordingly the processing can be efficiently distributed to the application server 21.

For the above-described embodiment, the case has been described where, when the number of requests being processed by a server exceeds the maximum processed-request number, the processing environment in which CAD runs on the server is transferred. However, the disclosed apparatus is not limited to this. For example, the request distribution apparatus 20 may transfer the processing environment for the request where the turnaround time from when a request is received from a client 12 until a response to the request is made is larger than the allowance to a server where the turnaround time is equal or smaller than the allowance. Accordingly, when it takes time to create a screen display image due to a large volume of data, the request distribution apparatus 20 can automatically switch the server that is implementing the CAD processing environment to the server with much higher performance. Accordingly, the request distribution apparatus 20 can prevent that the wait time of the client gets longer than the allowance.

The request distribution apparatus 20 may accept specifying of a server whose processing environments are all transferred for, for example, maintenance operations and, when a server is specified, may perform processing for transferring all request processing environments in which the specified server operates may be transferred to another server. Accordingly, even if a designer uses a server, the maintenance of the server can be performed without stopping the operations.

For the above described embodiment, the case has been described where the server is switched when the server does not include hardware to be used to implement a requested function for the requested processing. However, the disclosed apparatus is not limited to this. For example, when the performance of the hardware is too much for the requested function, the request distribution apparatus 20 may transfer the processing environment to a server with lower performance. For example, upon receiving a request for the Editing 1 function, the request distribution apparatus 20 may transfer the processing environment to a server that does not include any GPU and does not have GPGPU. In other words, the request distribution apparatus 20 may switch the server according to the requested function. Accordingly, the request distribution apparatus 20 can prevent that high-performance servers are much used for processing.

Each component of each device illustrated in the drawings is a functional idea and is not necessarily required to be configured physically as illustrated in the drawings. In other words, a specific state of separation and integration of each device is not limited to the state illustrated in the drawings and the devices may be configured to be entirely or partly separated or integrated functionally or physically according to various types of load or operating state and according to an arbitrary unit. For example, each processor of the receiver 50, the hardware specifying unit 51, the server specifying unit 52, the selecting unit 53, the transfer unit 54, and the transmitter 55 of the request distribution apparatus 20 may be integrated as appropriate. Furthermore, the processing performed by each processor may be separated into sets of processing performed by multiple processors properly. Furthermore, all of or an arbitrary part of each processing function implemented by each processor may be implemented by a CPU or using a program that is analyzed and executed by the CPU or may be implemented as wired-logic hardware.

Request Distribution Program

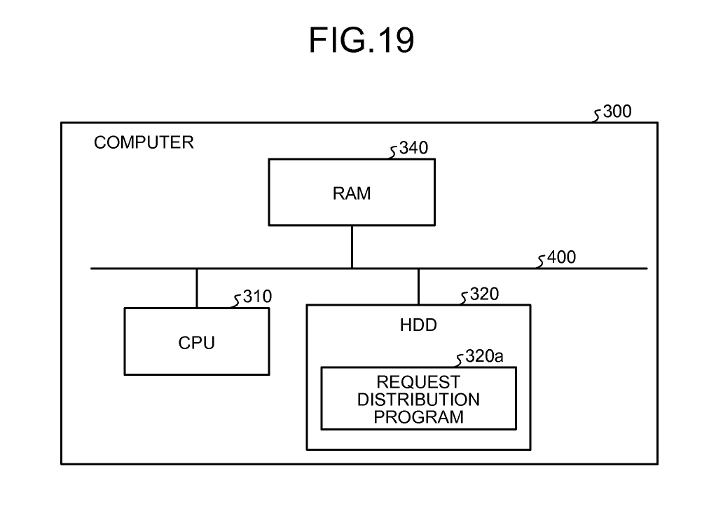

The various types of processing illustrated for the above-described embodiments can be also implemented by executing a prepared program with a computer system, such as a personal computer or a work station. An example of the computer system that executes the program with the same functions as those of the above-describe embodiments will be described below. FIG. 19 illustrates a computer that executes a request distribution program.

As illustrated in FIG. 19, a computer 300 includes a central processing unit (CPU) 310, a hard disk drive (HDD) 320, and a random access memory (RAM) 340. Each of the components 300 to 340 are connected to one another via a bus 400.

The HDD 320 previously stores a request distribution program 320a that implements the same functions as those of the receiver 50, the hardware specifying unit 51, the server specifying unit 52, the selecting unit 53, the transfer unit 54, and the transmitter 55 of the request distribution apparatus 20. The request distribution program 320a may be divided as appropriate.

The HDD 320 stores various types of information. For example, the HDD 320 stores various types of data used to distribute requests for, for example, selecting an OS or an area.

The CPU 310 reads the request distribution program 320a from the HDD 320 and executes the request distribution program 320a, so that the same operations as those of each processor of the embodiments are implemented. In other words, the request distribution program 320a implements the same operations as those of the receiver 50, the hardware specifying unit 51, the server specifying unit 52, the selecting unit 53, the transfer unit 54, and the transmitter 55.

The request distribution program 320a is not necessarily required to be stored in the HDD 320 from the beginning.

For example, the program is stored in a “portable physical medium”, such as a flexible disk (FD), a CD-ROM, a DVD disk, a magneto-optical disk, or an IC card, that is inserted into the computer 300. The computer 300 may read the program from the portable physical medium and execute the program.

Alternatively, the program may be stored in, for example, “another computer (or server)” that is connected to the computer 300 via, for example, a public line, the Internet, a LAN, or a WAN. The computer 300 may read the program from the computer and execute the program.

According to an aspect of an embodiment, processing can be distributed to servers efficiently.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
receiving a request regarding a function that is implemented by a server; and
specifying a server to implement a function requested by the received request on the basis of first information that associates one of multiple functions that are implemented by a server with a server that includes hardware necessary to implement the function.

2. The non-transitory computer-readable recording medium according to claim 1, wherein
the first information includes second information that associates one of the multiple functions with hardware necessary to implement the function and third information that associate a server and hardware of the server, and
the specifying specifies hardware necessary to implement the function requested by the received request on the basis of the second information,
the process further comprising
selecting a server that includes the specified hardware from among multiple servers on the basis of the third information.

3. The non-transitory computer-readable recording medium according to claim 2, the process further comprising
specifying, on the basis of fourth information that associates a request source of a request with a server that processes the last request from the request source, a server corresponding to the request source of the received request,
wherein the selecting selects the specified server when the specified server includes the specified hardware and selects a different server that includes the specified hardware when the specified server does not include the specified hardware.

4. The non-transitory computer-readable recording medium according to claim 3, the process further comprising:
transferring, when the specified server does not include the specified hardware, a processing environment of the specified server in which processing according to the received request is performed is transferred to the different server; and
transmitting the received request to the different server.

5. The non-transitory computer-readable recording medium according to claim 2, the process further comprising
when the number of requests from each request source that are processed by a selected server exceeds a given threshold, transferring the processing environment that corresponds to any one of the requests and in which processing according to the request is performed to a different server.

6. The non-transitory computer-readable recording medium according to claim 5, wherein
the transferring to the different server transfers, to a different server, the processing environment corresponding to any one of the requests where a processing time in which the different server processes the request is within an allowable time for the request.

7. The non-transitory computer-readable recording medium according to claim 2, wherein
the receiving receives requests for CAD functions including 3D display and analysis,
the specifying the hardware specifies hardware corresponding to a request on the basis of the second information that associates, per function, a GPU serving as hardware to be used to implement 3D display with a GPGPU serving as hardware to be used to implement analysis, and
the selecting the server selects, on the basis of the third information that associates, per server, information of whether there is a GPU and information of whether there is a GPGPU, a server including a GPU for a request for 3D display and selects a server including a GPGPU for a request for analysis.

8. The non-transitory computer-readable recording medium according to claim 1, the process further comprising:
accepting specifying of a server;
transferring all processing environments of a specified server to a different server.

9. A request distribution method performed by a computer, comprising:
receiving a request regarding a function that is implemented by a server; and
specifying a server to implement a function requested by the received request on the basis of first information that associates one of multiple functions that are implemented by servers with a server that includes hardware necessary to implement the function.

10. A information processing apparatus comprising:
a processor; and
a memory, wherein the processor executes a process comprising:
receiving a request regarding a function that is implemented by a server; and
specifying a server to implement a function requested by the received request on the basis of first information that associates one of multiple functions that are implemented by a server with a server that includes hardware necessary to implement the function.
